(19) United States
(12) Patent Application Publication
(10) Pub. No.: US 2005/0118525 A1
(43) Pub. Date: Jun. 2, 2005

(54) Donor substrate for laser induced thermal imaging method and organic electroluminescence display device fabricated using the substrate

(76) Inventors: Mu-Hyun Kim, Suwon-si (KR); Tae-Min Kang, Suwon-si (KR); Seong-Taek Lee, Suwon-si (KR)

Correspondence Address: Robert E. Bushnell, Suite 300, 1522 K Street, N.W., Washington, DC, 20005, US

(21) Appl. No.: 10/969,914

(22) Filed: Oct. 22, 2004

(30) Foreign Application Priority Data
Nov. 29, 2003 (KR) 2003-86123

(51) Int. Cl. G03C 1/76

(52) U.S. Cl. 430/200; 430/270.1; 430/964

(57) ABSTRACT

A donor substrate for laser induced thermal imaging method and an electroluminescence display device fabricated using the donor substrate and provides an organic electroluminescence display device having superior characteristics of emitting layer by protecting transfer layer from excessive heat by providing a donor substrate for laser induced thermal imaging comprising a base substrate, a light-heat converting layer formed on an upper part of the base substrate; and a transfer layer formed on an upper part of the light-heat converting layer and formed of an organic material, wherein a light absorbing material contained in the light-heat converting layer to generate heat by absorbing laser has a concentration gradient in a direction form a base substrate side to a transfer layer side in the light-heat converting layer, and an organic electroluminescence display device fabricated using the donor substrate.

### CLAIM OF PRIORITY

This application makes reference to, incorporates the same herein, and claims all benefits accruing under 35 U.S.C. §119 from an application for DONOR FILM FOR LASER INDUCED THERMAL IMAGING METHOD AND ELECTROLUMINESCENCE DISPLAY DEVICE MANUFACTURED USING THE SAME FILM earlier filed in the Korean Intellectual Property Office on 29 Nov. 2003 and there duly assigned Serial No. 2003-86123.

### BACKGROUND OF THE INVENTION

1. Field of the invention

The present invention relates to a donor substrate for laser induced thermal imaging method and an organic electroluminescence display device fabricated using the substrate, more particularly, to a donor substrate used for forming an organic layer for organic electroluminescence display device and an organic electroluminescence display device using the substrate.

2. Description of Related Art

Generally, an organic electroluminescence display device is formed of various layers including anode and cathode, hole injecting layer, hole transporting layer, light-emitting layer, electron transporting layer and electron injecting layer. The organic electroluminescence display device is divided into high molecular organic electroluminescence display device and small molecular organic electroluminescence display device according to materials used in the organic electroluminescence display device, wherein respective layers are introduced into the organic electroluminescence display device by vacuum deposition in case of the small molecular organic electroluminescence display device while an emitting device is fabricated in the organic electroluminescence display device by using spin-coating process in case of the high molecular organic electroluminescence display device.

When fabricating a single color device, a high molecular organic electroluminescence display device is simply fabricated using a spin coating process, wherein the high molecular organic electroluminescence display device has demerits that emission efficiency and life cycle are dropped although driving voltage is lower compared to a small molecular organic electroluminescence display device. Furthermore, when fabricating a full color device in which red, green and blue high molecules are patterned, the high molecular organic electroluminescence display device has problems that emission characteristics including emission efficiency and life cycle are deteriorated when using inkjet technology or a laser induced thermal imaging method.

Particularly, when patterning a single high molecular organic electroluminescence display device using a laser induced thermal imaging method, most of materials are not transferred on the single high molecular organic electroluminescence display device.

A method for forming patterns of a high molecular organic electroluminescence display device by laser induced thermal imaging method is disclosed in U.S. Pat. No. 5,998,085 to Thomas A. Isberg et al. and titled PROCESS FOR PREPARING HIGH RESOLUTION EMISSIVE ARRAYS AND CORRESPONDING ARTICLES, U.S. Pat. No. 6,214,520 to Martin B. Wolk et al. and titled THERMAL TRANSFER ELEMENT FOR FORMING MULTILAYER DEVICES and U.S. Pat. No. 6,114,088 to Martin B. Wolk et al. and titled THERMAL TRANSFER ELEMENT FOR FORMING MULTILAYER DEVICES.

In order to apply the laser induced thermal imaging method, at least light source, transfer substrate and substrate are required, and light coming out of the light source is absorbed into a light absorption layer of the transfer substrate and converted into a thermal energy so that a transfer layer forming material of the transfer substrate is transferred onto the substrate by the thermal energy, thereby forming a desired image as disclosed in U.S. Pat. No. 5,220,348 to David P. D'Aurelio and titled ELECTRONIC DRIVE CIRCUIT FOR MULTI-LASER THERMAL PRINTER, U.S. Pat. No. 5,256,506 to Ernest W. Ellis et al. and titled ABLATION-TRANSFER IMAGING/RECORDING, U.S. Pat. No. 5,278,023 to Richard E. Bills et al. and titled PROPELLANT-CONTAINING THERMAL TRANSFER DONOR ELEMENTS and U.S. Pat. No. 5,308,737 to Richard E. Bills et al. and titled LASER PROPULSION TRANSFER USING BLACK METAL COATED SUBSTRATES.

The laser induced thermal imaging method is used in fabrication of a color filter for liquid crystal display device and used to form patterns of emitting materials as disclosed in U.S. Pat. No. 5,998,085.

U.S. Pat. No. 5,937,272 to Ching W. Tang and titled PATTERNED ORGANIC LAYERS IN A FULL-COLOR ORGANIC ELECTROLUMINESCENT DISPLAY ARRAY ON A THIN FILM TRANSISTOR ARRAY SUBSTRATE relates to a method for forming a high quality patterned organic layer in a full color organic electroluminescence display device, and a donor supporting body obtained by coating an organic electroluminescence substance with a transferable coating material is used in the method. The donor supporting body is heated so that the organic electroluminescence substance is transferred onto a recess surface part of substrate for forming a colorized organic electroluminescence medium positioned in a targeted lower pixel, wherein the organic electroluminescence substance is vaporized to be transferred onto the pixel by applying heat or light to a donor substrate.

It is disclosed in U.S. Pat. No. 5,688,551 to Jon Eric Littman et al. and titled METHOD OF FORMING AN ORGANIC ELECTROLUMINESCENT DISPLAY PANEL that sub-pixels are formed on each pixel region by transferring organic electroluminescence substance from donor sheet to receiver sheet, wherein the sub-pixels are formed by transferring an organic electroluminescence substance having sublimation property from the donor sheet to the receiver sheet at low temperature of about 400° C. or less in the transferring process.

U.S. Pat. No. 6,228,555 to Thomas R. Hoffend, Jr. et al. entitled THERMAL MASS TRANSFER DONOR ELEMENT discusses a thermal mass transfer donor element is provided that includes a thermal transfer layer and a light-to-heat conversion layer, wherein the light-to-heat conversion layer has at least two regions exhibiting different absorption coefficients.

### SUMMARY OF THE INVENTION

Therefore, in order to solve problems in the prior art, it is an object of the present invention to provide a donor substrate for laser induced thermal imaging which is capable of preventing degeneration of transfer layer due to excessive temperature when forming an organic film layer comprising an emitting layer by laser induced thermal imaging during fabrication of an organic electroluminescence display device.

In order to achieve the foregoing object, the present invention provides a donor substrate for laser induced thermal imaging comprising a base substrate, a light-heat converting layer formed on an upper part of the base substrate, and a transfer layer formed on an upper part of the light-heat converting layer and formed of an organic material, wherein a light absorbing material contained in the light-heat converting layer to generate heat by absorbing laser has a concentration gradient in a direction form a base substrate side to a transfer layer side in the light-heat converting layer.

Furthermore, the present invention provides an organic electroluminescence display device characterized in that it is fabricated using the donor substrate for laser induced thermal imaging.

### BRIEF DESCRIPTION OF THE DRAWINGS

A more complete appreciation of the present invention, and many of the attendant advantages thereof, will become readily apparent as the same becomes better understood by reference to the following detailed description when considered in conjunction with the accompanying drawings in which like reference symbols indicate the same or similar components, wherein:

FIG. 1 is a cross sectional view for showing structure of one example of a full color organic electroluminescence display device;

FIG. 2 is a cross sectional view for showing structure of one example of a donor substrate for laser induced thermal imaging method;

FIG. 3 is a drawing for showing a transfer model in case of using the donor substrate of FIG. 2;

FIG. 4 is a drawing for illustrating transfer mechanism when transfer patterning an organic emitting film used in an organic electroluminescence display device by using laser according to the present invention;

FIG. 5 is a drawing for showing structure of a donor substrate for laser induced thermal imaging method according to a preferred embodiment of the present invention;

FIG. 6 is a graph for showing efficiency of an organic electroluminescence display device according to thickness and absorption ratio of light-heat converting layer according to the present invention; and

FIG. 7 is a drawing for describing a method for laser induced thermal imaging using a donor substrate according to the present invention.

### DETAILED DESCRIPTION OF THE INVENTION

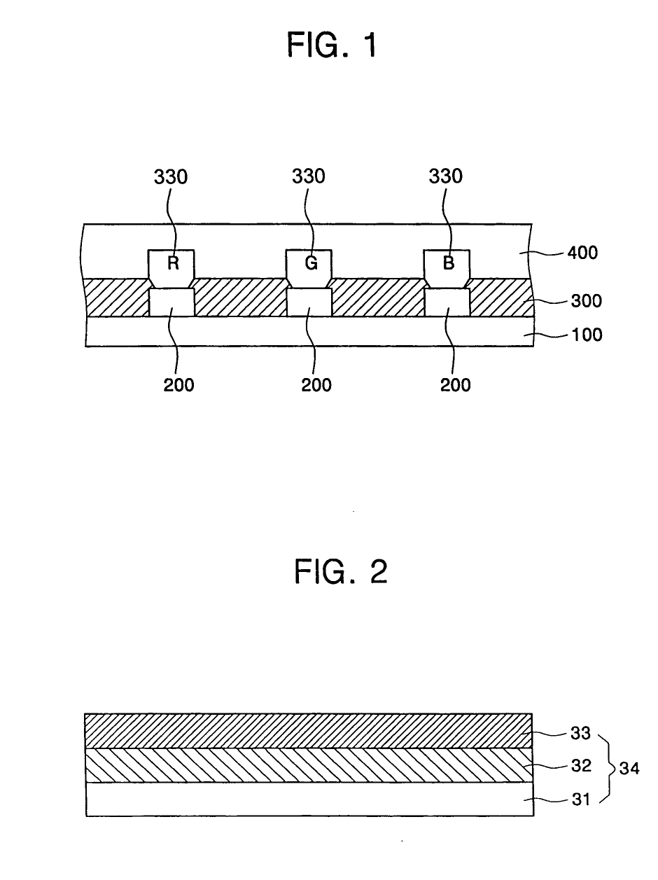

FIG. 1 is a cross sectional view for showing structure of one example of a full color organic electroluminescence display device.

Referring to FIG. 1, first electrode 200 is patterned thus formed on an insulating substrate 100. The first electrode 200 is formed of a transparent electrode in case of a bottom emitting type full color organic electroluminescence display device and formed of a conductive metal comprising a reflection film in case of a top emitting type full color organic electroluminescence display device.

A pixel defining layer (PDL) 300 is formed of an insulating material on an upper part of the first electrode 200 to define pixel region and insulate between emitting layers.

An organic film layer 330 comprising an organic light-emitting layer is formed on the pixel region defined by the pixel defining layer (PDL) 300, and the organic film layer 330 further comprises one or more of layers selected from hole injecting layer, hole transporting layer, hole blocking layer, electron transporting layer and electron injecting layer besides the organic light-emitting layer, wherein both high molecular substance and small molecular substance can be used as the organic light-emitting layer.

Second electrode 400 is formed on the organic film layer 330, after forming the organic film layer 330, and the pixel defining layer (PDL) 300. The second electrode 400 is formed of a conductive metal layer comprising the reflection film if the first electrode 200 is a transparent electrode, and formed of a transparent electrode if the first electrode 200 is a conductive metal layer comprising the reflection film. An organic electroluminescence display device is completed by sealing the organic electroluminescence display device after forming the second electrode 400.

However, as illustrated in FIG. 2, a donor substrate 34 for laser induced thermal imaging comprises base substrate 31, light-heat converting layer 32 and transferring layer 33 and further comprises a buffer layer (not shown on FIG. 2) in case of forming a light-emitting layer using laser induced thermal imaging.

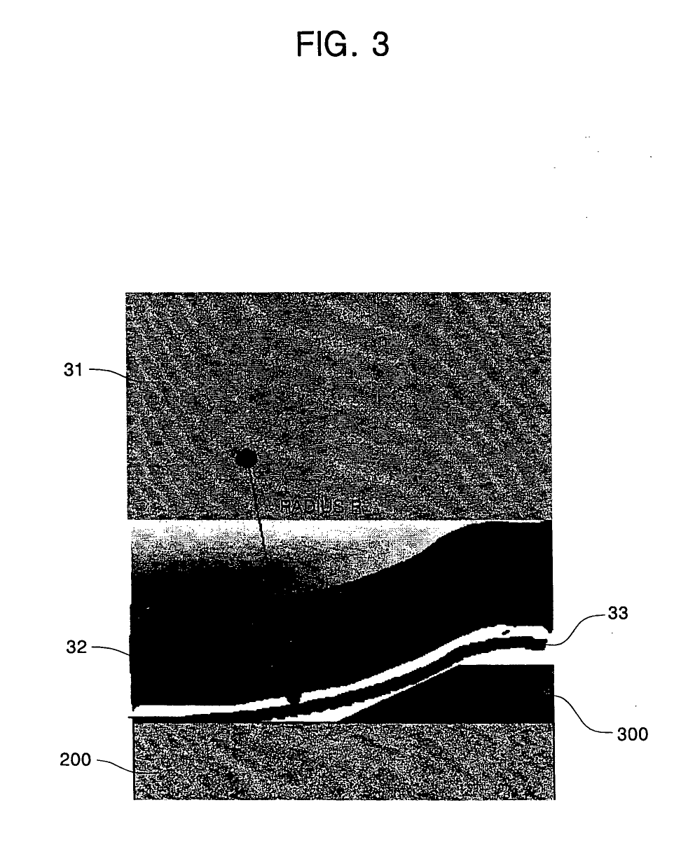

FIG. 3 relates to a transfer model in case of using a donor substrate. The transfer layer is separated from a base substrate and transferred to a substrate of an organic electroluminescence display device as a transfer layer 33 is being expanded according to expansion of a light-heat converting layer 32 during laser irradiation as illustrated in FIG. 3. Therefore, there are problems in that excessive temperature results in defects or degeneration of emitting materials during patterning if heat changed is not controlled often since a patterned material is transferred onto a lower substrate through an energy for converting laser beam into heat.

The present invention will now be described in detail in connection with preferred embodiments with reference to the accompanying drawings. For reference, like reference characters designate corresponding parts throughout several views.

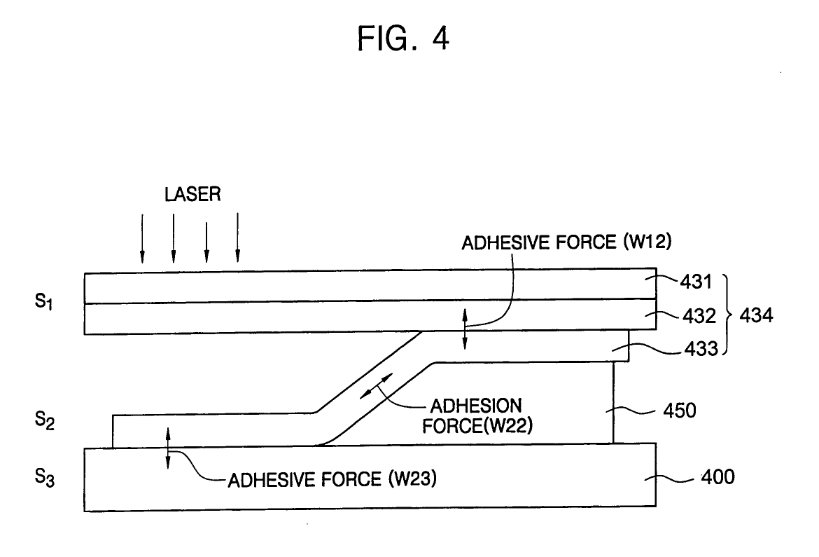

FIG. 4 is a drawing for illustrating transfer mechanism when transfer patterning an organic emitting film used in an organic electroluminescence display device by using laser according to the present invention.

A mechanism for transfer patterning an organic film S2 using an ordinary laser is that the organic film S2 should be separated from a part on which a laser beam is not irradiated as an organic film S2 adhered to a substrate S1 is being detached from the substrate S1 to be transferred to a substrate S3 by action of laser as illustrated in FIG. 4.

Factors for affecting transfer characteristics are first adhesive force W12 between substrate S1 and substrate S2, adhesion force W22 of the substrate S2, and second adhesive force W23 between the substrate S2 and substrate S3.

The first and second adhesive forces and adhesion force are represented as in the following expressions using surface tensions γ1, γ2 and γ3 and interfacial tensions γ12 and γ23 of respective layers.
W12=γ1+γ2−γ3
W22=2γ2
W23=γ2+γ3−γ23

In order to improve laser transfer characteristics, the adhesion force of a substrate should be less than adhesive forces between the respective substrates.

Generally, an organic material is used in an organic electroluminescence display device as a material for forming respective layer of the organic electroluminescence display device, and fine patterns of light-emitting layer can be formed by transferring an emitting material 433 from a donor substrate 434 to the organic electroluminescence display device 400, thereby generating mass transition 450 since the first and second adhesive forces are greater than the adhesion force if a small molecular material is used as the organic material. The fine patterns of the light-emitting layer can formed, and possibility of mis-alignment is decreased by transferring the light-emitting material 433 from the donor substrate 434 to the organic electroluminescence display device.

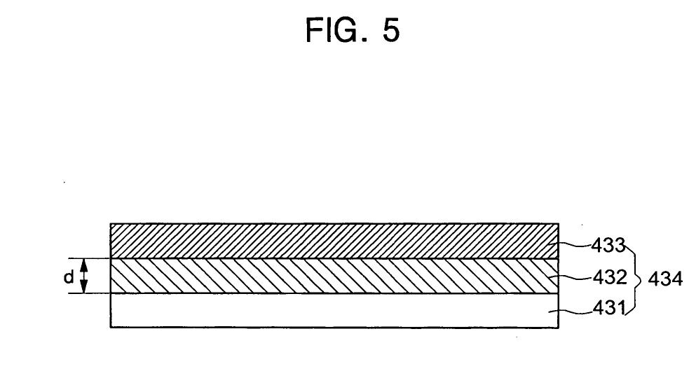

FIG. 5 is a drawing for showing structure of a donor substrate 434 for laser induced thermal imaging method according to first preferred embodiment of the present invention.

Referring to FIGS. 4 and 5, the donor substrate 434 has a structure comprising a base substrate 431, a light-heat converting layer 432 formed on base substrate 431, and a transfer layer 433 formed on the light-heat converting layer 432 and laid up all over the base substrate 431.

The donor substrate 434 of can be used with structure of the substrate being changed according to its applications. For example, a buffer layer (not illustrated on FIG. 5) for protecting a gas generating layer (not illustrated on FIG. 5) or the light-heat converting layer 432 can be additionally formed between light-heat converting layer 432 and base substrate 431 to improve sensitivity of the substrate.

The base substrate 431 is formed of transparent polymers including polyester such as polyethylene terephthalate, polyacryl resin, polyepoxy, polyethylene, and polystyrene. Particularly, a polyethylene terephthalate film is mainly used as the transparent polymer. It is preferable that the base substrate 431 has a thickness of 10 to 500 μm. The base substrate functions as a supporting substrate, and a composite multi-component substrate can be also used as the base substrate.

The light-heat converting layer 432 comprises a light absorbing material having a property for absorbing light in the infrared ray-visible ray range. The light absorbing material includes colorants such as carbon black, graphite, infrared dyes, infrared pigments and dyes, and a polymer bonding resin for fixing the light absorbing material. That is, the light-heat converting layer 432 is formed by mixing the light absorbing material with the polymer bonding resin.

It is preferable that the carbon black or graphite has a grain size of 0.5 μm or less, and ordinary pigments or dyes are used as the pigments or dyes.

On the other hand, the polymer bonding resin is is a material selected from the group consisting of a (meta)acrylate oligomer selected from the group consisting of acryl (meta)acrylate oligomer, ester (meta)acrylate oligomer, epoxy (meta)acrylate oligomer and urethane (meta)acrylate oligomer, a mixture of the (meta)acrylate oligomer and (meta)acrylate monomer, and (meta)acrylate monomer.

The optical density of the light-heat converting layer 432 is 2.0 or less, and is preferably 1.5 or less, wherein the optical density is amount of light when luminosity becomes the certain intensity after light having certain intensity and wavelength passes through a solution layer. An amount of light transmitted to a transfer layer after passing through the light-heat converting layer is increased.

Therefore, as energy transferred to a transfer layer 433 through the light-heat converting layer 432 is high, it is not preferable that the optical density of the light-heat converting layer 432 is 2.0 or more since the transfer layer can be damaged by thermal energy.

Furthermore, amount of heat transferred to the transfer layer 433 is controlled so that the transfer layer 433 is not damaged by heat by forming the light-heat converting layer 432 in such a way that a light absorbing material is not uniformly mixed with polymer bonding resin, and the closer the light-heat converting layer 432 is to the transfer layer 433, the lower the concentration of the light absorbing material is, thereby lowering light absorbing ratio of laser beam as the light-heat converting layer 432 is getting closer to the transfer layer 433 so that a conversion amount of light into heat is lowered.

Therefore, a donor substrate 434 of the present invention is formed in such a manner that the light absorbing material contained in the polymer bonding resin has a concentration gradient so that concentration of the light absorbing material contained in the polymer bonding resin is high at the side closer to the base substrate 431, and the closer the donor substrate 434 is to the transfer layer 433, the lower concentration of the light absorbing material is.

The donor substrate 434 is formed in such a way that the concentration gradient is continuously varied, and the light-heat converting layer 432 is discontinuously formed.

On the other hand, heat transferred to the transfer layer 433 is controlled by forming the light-heat converting layer 432 in such a manner that concentration of the light absorbing material contained in the polymer bonding resin is changed, and thickness d of the light-heat converting layer 432 is formed to a certain thickness or more as constantly maintaining concentration of the light absorbing material.

If the thickness d of the light-heat converting layer 432 is too thin, the energy absorption ratio is lowered so that expansion pressure is lowered due to low light-heat converting energy, and transmission energy is increased so that substrate circuits of an organic electroluminescence display device are damaged accordingly.

Furthermore, an edge open defect of the transfer layer, caused by a stepped surface level generated by a pixel defining film for defining pixel region of an organic electroluminescence display device, is reduced only by maintaining the light-heat converting layer 432 to a certain thickness or less when the light-heat converting layer 432 is expanded by laser energy during laser induced thermal imaging, thereby decreasing a radius of curvature during expansion of the light-heat converting layer 432.

It is not preferable that the light-heat converting layer 432 be too thick since laser energy is not transferred to the light-heat converting layer as a whole during laser irradiation, resulting in defective transfer characteristics.

Therefore, the light-heat converting layer 432 has a thickness of 2 to 10 μm, preferably 3 to 7 μm.

Furthermore, heat transferred to the transfer layer 433 is controlled by forming the polymer bonding resin composing the light-heat converting layer 432 to a certain thickness or more while maintaining a certain concentration gradient of the light-heat converting layer 432, wherein the concentration gradient is continuous or discontinuous so that concentration of the light-heat converting layer 432 is formed, and thickness of the light-heat converting layer is 2 to 10 μm, preferably 3 to 7 μm.

An organic film containing the light absorbing material is formed by ordinary film coating methods including extrusion, spin and knife coating.

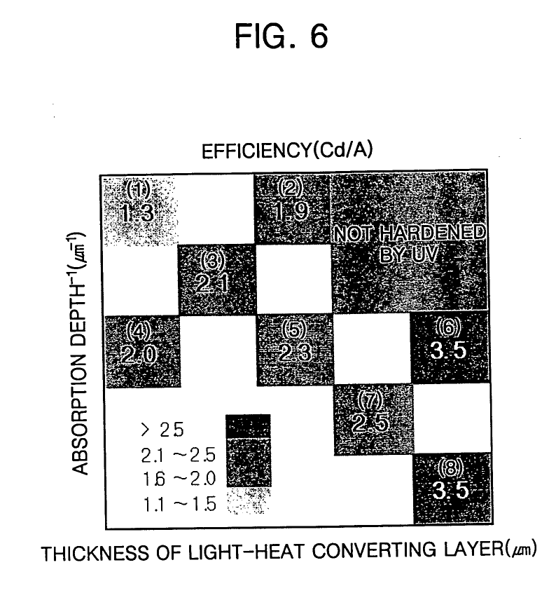

FIG. 6 is a graph for showing emission efficiency of an organic electroluminescence display device according to a thickness and absorption ratio, in which it can be seen that the thicker the thickness of the light-heat converting layer is, the higher the emission efficiency of the organic electroluminescence display device is if absorption ratio of the light absorbing material is constant, when comparing areas (4), (5) and (6) with each other.

Furthermore, it can be seen in FIG. 6 that the higher the absorption ratio of the light absorbing material is, the lower the emission efficiency of the organic electroluminescence display device is if the light-heat converting layer 432 is constant when comparing (2) with (5).

Therefore, it can be seen from (6) and (8) in FIG. 6 that the organic electroluminescence display device has the highest emission efficiency when the light-heat converting layer has constant thickness and low light absorbing ratio.

On the other hand, the gas generating layer plays a role of providing transfer energy by causing decomposition reaction as absorbing light or heat, thereby emitting nitrogen gas or hydrogen gas, and the gas generating layer is formed of a material selected from pentaerythritol tetranitrate (PETN), trinitrotoluene (TNT), etc.

On the other hand, the transfer layer 433 is formed of at least one material selected from high or small molecular organic electroluminescence material, hole transfer organic material and electron transfer organic material so that the transfer layer 433 corresponds to characteristics of an organic electroluminescence display device to be fabricated, wherein the transfer layer 433 is formed to a coating thickness of 100 to 50,000 Å by ordinary coating methods including extrusion, spin-coating, knife coating, vacuum deposition and chemical vapor deposition (CVD).

As described in the above, characteristics of the transfer layer are prevented from being deteriorated by forming the light-heat converting layer 432 to a thick thickness and having light absorbing layer maintain a certain concentration gradient according to the thickness of the light absorbing layer or forming the light-heat converting layer 432 to a certain thickness or more, thereby lowering temperature of the light-heat converting layer 432 transferred to the transfer layer.

Fine patterns are easily formed on a donor substrate for laser induced thermal imaging disclosed in the present invention, particularly when an emission device is an organic electroluminescence display device formed of an organic material.

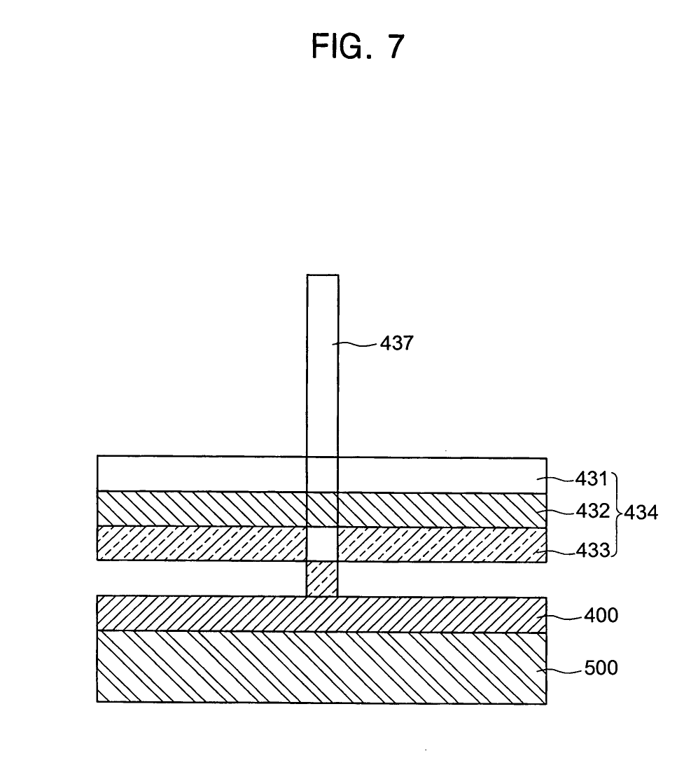

Referring to FIG. 7, a method for forming fine patterns of organic thin film on an organic electroluminescence display device using a donor substrate according to the present invention is described in detail as follows. Application of the donor substrate of the present invention is not limited to the organic electroluminescence display device although an organic electroluminescence display device is mentioned as one application example of a donor substrate of the present invention for convenience of description in the following description.

FIG. 7 is a drawing for explaining a method for performing laser induced thermal imaging using a donor substrate 434 according to the present invention. First, a transparent electrode layer 400 is formed on a transparent substrate 500. Separately from the transparent electrode layer, a donor substrate 434 is prepared by sequentially coating the light-heat converting layer 432 and the transfer layer 433 on the base substrate 431.

The transfer layer 433 is formed by coating an organic thin film forming material on the light-heat converting layer 432, wherein a certain content of additive can be added to the transfer layer to improve various characteristics of the transfer layer. For example, dopant can be added to the transfer layer to increase efficiency of light-emitting layer. The transfer layer 433 is formed by using ordinary film coating methods such as extrusion, spin coating and knife coating.

The transfer layer 433 is formed by laying up one or two layers of the foregoing organic film.

After forming the transfer layer 433, the donor substrate 434 is arranged at a position spaced apart from the transparent electrode layer 400 formed substrate 500 in a certain distance, and an energy source 437 is irradiated onto the donor substrate 434.

The energy source 437 activates the light-heat converting layer 432 by passing through base substrate 431 via a transfer apparatus and emits heat by pyrolysis reaction caused by the light absorbing material contained in the light-heat converting layer 432.

As the light-heat converting layer 432 of the donor substrate 434 is being expanded by the emitted heat, the transfer layer 433 is separated from the donor substrate 434 so that a light-emitting layer that is a transfer material is transferred as a desired pattern and thickness on a pixel region defined by pixel defining layer on an upper part of an organic electroluminescence display device.

However, it is necessary to control heat transferred since the produced heat is transferred to the transfer layer 433 to damage the transfer layer 433 if much of heat is emitted by the pyrolysis reaction as described in the above.

Therefore, the heat transferred to the transfer layer 433 is controlled to protect the transfer layer 433 by forming the light-heat converting layer 432 in such a manner that concentration of the light absorbing material contained in the polymer bonding resin for forming the light-heat converting layer 432 is lowered from the substrate (431) side to the transfer layer (433) side so that the closer the light-heat converting layer 432 is, the less amount of heat produced by pyrolysis reaction caused by light is.

The concentration gradient of the light absorbing material can be continuously formed or discontinuously formed.

Additionally, less amount of heat is transferred to the transfer layer 433 as a light and heat transfer passageway is being lengthened by constantly maintaining concentration of the light absorbing material and maintaining thickness of a polymer bonding resin composing the light-heat converting layer 432 to a certain thickness, wherein thickness of the light-heat converting layer 432 is 2 to 10 μm, preferably 3 to 7 μm.

Furthermore, heat transferred to the transfer layer 433 is controlled by forming the polymer bonding resin composing the light-heat converting layer 432 to a certain thickness or more as maintaining a certain concentration gradient of the light-heat converting layer 432, wherein the concentration gradient is continuous or discontinuous so that a concentration layer is formed, and thickness of the light-heat converting layer 432 is 2 to 10 μm, preferably 3 to 7 μm.

On the other hand, a laser, xenon (Xe) lamp, flash lamp, etc. can be used as an energy source in the present invention. The laser among the energy sources is preferably used since it obtains the most superior transfer effect, wherein all general lasers including solid, gas, semiconductor and dyes are used as the laser, and a circular or other shaped laser beam can be used.

A heat treatment process for solidifying and adhering transferred material is performed after performing the foregoing transfer process.

The laser induced thermal imaging of the transfer material is performed in one step or multi-steps. That is, an organic thin film layer to be transferred is formed to a required thickness by one transfer or several repeated transfers. However, it is preferable that the organic thin film layer is formed by one transfer considering process convenience and stability.

As described in the above, the present invention prevents characteristics of a light-emitting layer formed on the transfer layer from being deteriorated by the heat by forming the light-heat converting layer in such a way that the light absorbing material contained in the light-heat converting layer of a donor substrate for laser induced thermal imaging has a concentration gradient, or the light-heat converting layer is formed to a certain thickness or more, thereby decreasing amount of heat transferred to the transfer layer.

While the invention has been particularly shown and described with reference to preferred embodiments thereof, it will be understood by those skilled in the art that the foregoing and other changes in form and details may be made therein without departing from the spirit and scope of the invention.

1. A donor substrate for laser induced thermal imaging comprising:
a base substrate;
a light-heat converting layer formed on the base substrate; and
a transfer layer formed on the light-heat converting layer and formed of an organic material,
wherein a light absorbing material contained in the light-heat converting layer to generate heat by absorbing laser has a concentration gradient in a direction form a base substrate side to a transfer layer side in the light-heat converting layer, and the light-heat converting layer has a thickness of 2 to 10 μm.

2. The donor substrate for laser induced thermal imaging according to claim 1, wherein the light-heat converting layer is formed by mixing the light absorbing material with a polymer bonding resin.

3. The donor substrate for laser induced thermal imaging according to claim 1, wherein the light absorbing material is a material selected from the group consisting of carbon black, graphite, infrared dyes, infrared pigments and dyes.

4. The donor substrate for laser induced thermal imaging according to claim 2, wherein the polymer bonding resin is a material selected from the group consisting of a (meta)acrylate oligomer selected from the group consisting of acryl (meta)acrylate oligomer, ester (meta)acrylate oligomer, epoxy (meta)acrylate oligomer and urethane (meta)acrylate oligomer, a mixture of the (meta)acrylate oligomer and (meta)acrylate monomer, and (meta)acrylate monomer.

5. The donor substrate for laser induced thermal imaging according to claim 1, wherein the light-heat converting layer has a thickness of 3 to 7 μm.

6. The donor substrate for laser induced thermal imaging according to claim 1, wherein the concentration gradient is continuous.

7. The donor substrate for laser induced thermal imaging according to claim 1, wherein the concentration gradient is discontinuous.

8. The donor substrate for laser induced thermal imaging according to claim 1, wherein optical density of the light-heat converting layer is 2.0 or less.

9. The donor substrate for laser induced thermal imaging according to claim 8, wherein optical density of the light-heat converting layer is 1.5 or less.

10. A donor substrate for laser induced thermal imaging comprising:
a base substrate;
a light-heat converting layer having a thickness of 2 to 10 μm formed on the base substrate; and
a transfer layer formed on the light-heat converting layer.

11. The donor substrate for laser induced thermal imaging according to claim 10, wherein a light absorbing material for generating heat by absorbing laser is contained in the light-heat converting layer in a uniformed concentration.

12. The donor substrate for laser induced thermal imaging according to claim 10, wherein the light-heat converting layer is formed by mixing the light absorbing material with a polymer bonding resin.

13. The donor substrate for laser induced thermal imaging according to claim 10, wherein the light absorbing material is a material selected from the group consisting of carbon black, graphite, infrared dyes, infrared pigments and dyes.

14. The donor substrate for laser induced thermal imaging according to claim 12, wherein the polymer bonding resin is a material selected from the group consisting of a (meta)acrylate oligomer selected from the group consisting of acryl (meta)acrylate oligomer, ester (meta)acrylate oligomer, epoxy (meta)acrylate oligomer and urethane (meta)acrylate oligomer, a mixture of the (meta)acrylate oligomer and (meta)acrylate monomer, and (meta)acrylate monomer.

15. The donor substrate for laser induced thermal imaging according to claim 10, wherein optical density of the light-heat converting layer is 2.0 or less.

16. The donor substrate for laser induced thermal imaging according to claim 10, wherein optical density of the light-heat converting layer is 1.5 or less.

17. The donor substrate for laser induced thermal imaging according to claim 11, wherein the heat generated by the light absorbing material causes the transfer layer to transfer when forming an organic electroluminescence display device.

18. An organic electroluminescence display device fabricated using the donor substrate for laser induced thermal imaging of claim 1.
